(19) United States
(12) Patent Application Publication
(10) Pub. No.: US 2010/0074071 A1
(43) Pub. Date: Mar. 25, 2010

(54) METHOD FOR READING DISK MANAGEMENT DATA OF AN OPTICAL DISK

(75) Inventors: Ping-Tsai TSAI, Kaohsiung City (TW); Chih-Tien CHEN, Taipei City (TW); Ya-Fang NIEN, Hsin-Chu City (TW); Sung-Yang WU, Hsinchu City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: MEDIATEK INC., Hsin-Chu (TW)

(21) Appl. No.: 12/235,098

(22) Filed: Sep. 22, 2008

(51) Int. Cl. G11B 20/10

(52) U.S. Cl. 369/47.1; G9B/20.009

(57) ABSTRACT

The invention provides a method for reading disk management data of an optical disk. In one embodiment, the disk management data comprises data layout information of the optical disk, and a plurality of disk management data copies of the disk management data is stored on the optical disk. First, a first disk management data copy selected from the plurality of disk management data copies is read from the optical disk. An accuracy measure of the first disk management data copy is then calculated to determine whether the accuracy measure of the first disk management data copy is acceptable. When the accuracy measure of the first disk management data copy is acceptable, the optical disk is accessed according to the first disk management data copy.

### BACKGROUND OF THE INVENTION

1. Field of the Invention

The invention relates to optical disks, and more particularly to disk management data of optical disks.

2. Description of the Related Art

Before an optical disk drive accesses an optical disk loaded therein, the optical disk drive must know how data was stored on the optical disk. For example, the optical disk drive knows starting addresses of all sectors of the optical disk, thereby searching the sectors for a target address accessed by a host. Such data layout information is stored on a specific area of an optical disk and read as a guide for all subsequent access operations of the optical disk drive.

Each type of optical disk has a specific data structure format for recording the aforementioned data layout information. In addition, whenever an optical disk is written with new data, the data layout information may be updated to reflect the latest data layout pattern. Because slight data layout information errors may lead to serious optical disk drive access operation malfunctions, the data layout information should be errorless, accessing the data layout information is crucial for an optical disk.

To ensure accuracy of the data layout information, the data layout information is often duplicated to obtain multiple copies stored on different portions of an optical disk. Thus, when a copied data layout information is not available due to defects such as disk surface scratches, the optical disk drive can still access the data layout information via the other copies. For example, a rewritable blu-ray disk (BD-RE) has four data management (DMA) zones for respectively storing a copy of the data layout information, and each copy is referred to as a data management structure (DMS). In addition, a rewritable digital versatile disk (DVD-RW) has multiple recording management zones (RMZ) for respectively storing a copy of the data layout information, wherein each copy is referred to as recording management data (RMD). Note that the copies of the data layout information are referred to as disk management data copies in the specification.

Referring to FIG. 1, a stipulated data structure of a rewritable blu-ray disk is shown. Four data management zones DMA1, DMA2, DMA3, and DMA4 are stored at different addresses of the blu-ray disk. The two data management zones DMA1 and DMA2 are stored at an inner portion of the blu-ray disk, and the two data management zones DMA3 and DMA4 are stored at an outer portion of the blu-ray disk. Each DMA zones stores a data management structure comprising a disk definition structure (DDS) and a defect list (DFL). The disk definition structure stores start addresses and end addresses of all sectors of the blu-ray disk. The defect list stores addresses of all defect blocks and corresponding replacement blocks of the blu-ray disk.

When an optical disk drive requires data layout information such as a disk definition structure and a defect list of a blu-ray disk, the optical disk drive must read all four data management zones DMA1, DMA2, DMA3, and DMA4. Referring to FIG. 2, a flowchart of a conventional method 200 for reading data layout information of a rewritable blu-ray disk is shown. First, an optical disk drive reads a first data management zone DMA1 of the blu-ray disk to obtain a first data management structure (step 202). Similarly, the optical disk drive sequentially reads a second data management zone DMA2, a third data management zone DMA3, and a fourth data management zone DMA4 of the blu-ray disk to respectively obtain a second data management structure, a third data management structure, and a fourth data management structure (steps 204˜208). The optical disk drive then compares the first, second, third, and fourth data management structures to determine whether update counts of the first, second, third, and fourth data management structures are equal (steps 210 and 212). An update count of a data management structure records a frequency with which the data management structures have been updated. If the update counts of the data management structures are equal, the data management structures are all ensured of having stored the latest data layout information, and the optical disk drive then accesses the blu-ray disk according to the data layout information of any of the data management structures (step 214). Otherwise, when update counts of the data management structures are not equal, because a greater update count indicates a newer updated version of the data management structure, the optical disk drive selects a latest data management structure with the greatest update count from the data management structures (step 216), and accesses the blu-ray disk according to the latest data management structure (step 218).

The conventional method 200 shown in FIG. 2, however, requires a lot of time to read all four data management structures DMA1˜DMA4 at steps 202˜208. Specifically, because the first and second data management zones DMA1 and DMA2 are disposed at an inner portion of the blu-ray disk, and the third and fourth data management zones DMA3 and DMA4 are disposed at an outer portion of the blu-ray disk, an optical disk drive must move a pickup head from the inner portion to the outer portion of the blu-ray disk, wasting a lot of time and delaying the entire reading process of the data management structures. In addition, the four data management structures DMA1˜DMA4 basically holds similar data layout information. Thus, a method for reading disk management data of an optical disk with reduced time, such as the data management structures of a BD-RE disk or recording management data of a DVD-RW disk, is required to improve performance of an optical disk drive.

### BRIEF SUMMARY OF THE INVENTION

The invention provides a method for reading disk management data of an optical disk. In one embodiment, the disk management data comprises data layout information of the optical disk, and a plurality of disk management data copies of the disk management data are storied on the optical disk. First, a first disk management data copy selected from the plurality of disk management data copies is read from the optical disk. An accuracy measure of the first disk management data copy is then calculated to determine whether the accuracy measure of the first disk management data copy is acceptable. When the accuracy measure of the first disk management data copy is acceptable, the optical disk is accessed according to the first disk management data copy.

The invention provides another method for reading disk management data of an optical disk. In one embodiment, the disk management data comprises data layout information of the optical disk, and a plurality of disk management data copies of the disk management data are storied on the optical disk. First, a first disk management data copy selected from the plurality of disk management data copies is read from the optical disk. A second disk management data copy selected from the plurality of disk management data copies is then read from the optical disk. The first disk management data copy is compared with the second disk management data copy to determine whether data of the first disk management data copy and the second disk management data copy are identical. When data of the first disk management data copy and the second data copy are identical, the optical disk is accessed according to the first disk management data copy or the second data copy.

The invention also provides an optical disk drive. In one embodiment, the optical disk drive accesses an optical disk, wherein a plurality of disk management data copies of disk management data of the optical disk are storied on the optical disk, and the disk management data comprises data layout information of the optical disk. In one embodiment, the optical disk drive comprises a pickup head and a controller. The pickup head reads a first disk management data copy selected from the plurality of disk management data copies from the optical disk. The controller calculates an accuracy measure of the first disk management data copy, determines whether the accuracy measure of the first disk management data copy is acceptable, and controls the pickup head to access the optical disk according to the first disk management data copy when the accuracy measure of the first disk management data copy is acceptable.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 shows a data structure of a rewritable blu-ray disk;

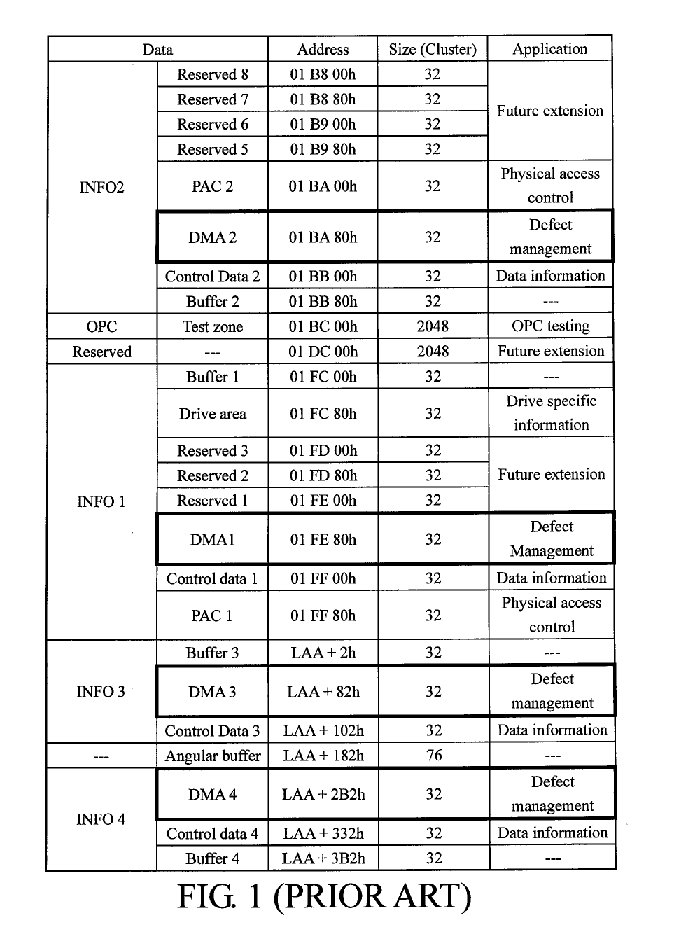

FIG. 2 is a flowchart of a conventional method for reading data layout information of a rewritable blu-ray disk;

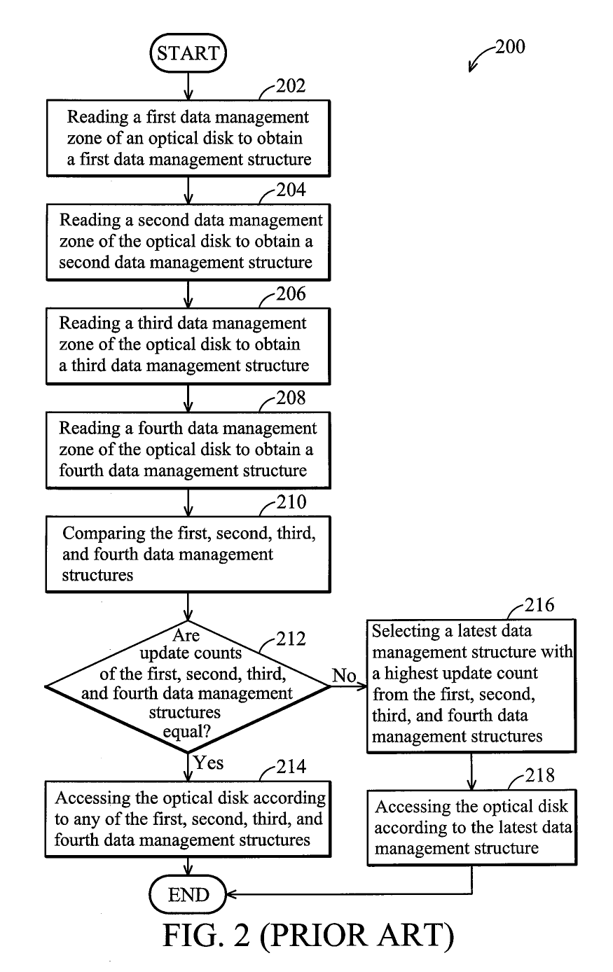

FIG. 3 is a block diagram of an optical disk drive reading disk management data of an optical disk according to the invention;

FIG. 4 is a flowchart of a method for reading disk management data of an optical disk according to the invention; and

FIG. 5 is a flowchart of a method for reading disk management data of an optical disk according to the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

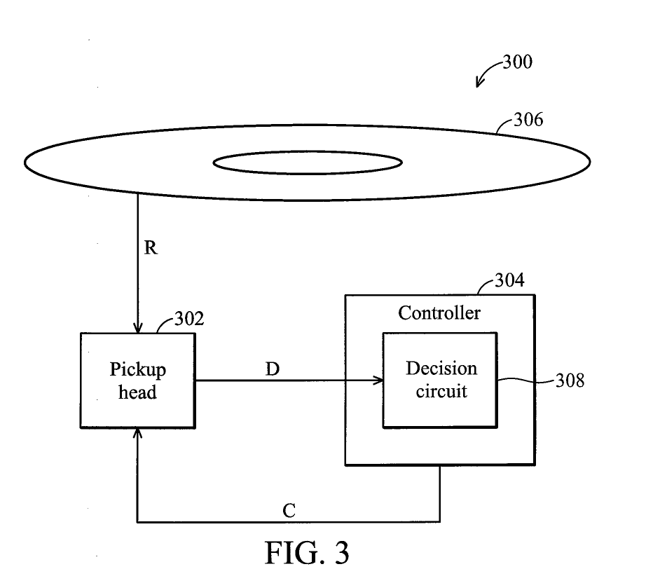

Referring to FIG. 3, a block diagram of an optical disk drive 300 reading disk management data of an optical disk 306 according to the invention is shown. The optical disk drive 300 comprises a pickup head 302 and a controller 304. The controller 304 generates a control signal C to control motion of the pickup head 302, thereby moving the pickup head 302 to a position for focusing on the disk surface portion storing target data. The pickup head 302 may emit a laser beam projected to the surface of the optical disk 306, and detects reflection R from the surface of the optical disk 306 to generate a data signal D, thereby reading data recorded on the optical disk 306. The controller 304 then receives the data signal D and transfers the data to a host.

The optical disk drive 300 accesses the optical disk 306 according to data layout information of the optical disk 306, such as starting addresses and ending addresses of sectors of the optical disk 306. The optical disk drive 300 therefore may retrieve the data layout information of the optical disk 306 before the optical disk 306 is further accessed. Disk management data comprising the data layout information is duplicated into multiple disk management data copies respectively stored on different portions of the optical disk 306. When the optical disk 306 is a rewritable blu-ray (BD-RE) disk, the disk management data copies refer to the data management structures (DMS) of the rewritable blu-ray disk. When the optical disk 306 is a rewritable digital versatile (DVD-RW) disk, the disk management data copies refer to the recording management data (RMD) of the rewritable digital versatile disk. The optical disk drive 300 therefore reads the disk management data copies to obtain the data layout information of the optical disk 306.

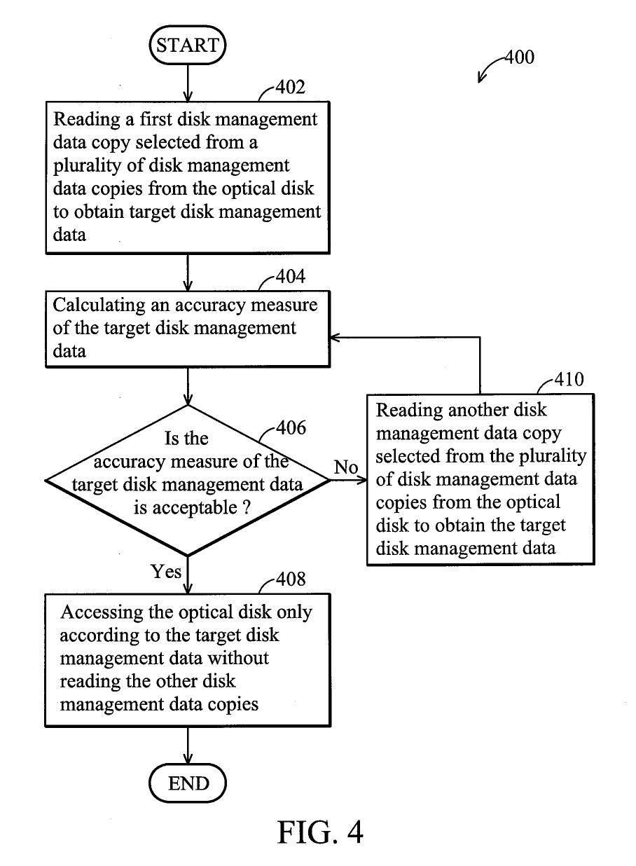

Referring to FIG. 4, a flowchart of a method 400 for reading disk management data of an optical disk according to the invention is shown. The controller 304 first directs the pickup head 302 to read a first disk management data copy from the optical disk 306 to obtain target disk management data (step 402), wherein the first disk management data copy is one of the multiple disk management data copies stored on the optical disk 306. In one embodiment, each disk management data copy comprises an update count recording a frequency with which the disk management data copy has been updated, and the first disk management data copy may have the greatest update count in comparison with those of the other disk management data copies. For example, if the optical disk is a BD-RE disk, the data management zones are always updated in the sequence of DMA1, DMA2, DMA3, and DMA4. Thus, if a power of an optical disk drive is shut off when the optical disk drive updates the data management zones, the first data management zone DMA1 with the greatest priority sequence would have the greatest update count when compared to the other data management zones which have not been updated. The pickup head 302 therefore reads the first data management zone DMA1 as the first disk management data copy at step 402.

After the target disk management data is obtained, a decision circuit 308 of the controller 304 then calculates an accuracy measure of the target disk management data (step 404). The accuracy measure is one kind of disc quality measure method such as error rate. In one embodiment, the accuracy measure is an error rate determined according to an error correction code (ECC) of the first disk management data copy. In another embodiment, the accuracy measure is an error detection code (EDC) check of the first disk management data copy. However, there may be other accuracy measures according to different applications. The decision circuit 308 of the controller 304 then determines whether the accuracy measure of the target disk management data is acceptable (step 406). For example, when the accuracy measure is an EDC check, the decision circuit 308 checks whether the EDC is correct. When the accuracy measure is an error rate, the decision circuit 308 compares the error rate with a threshold. If the error rate is smaller than the threshold, the target disk management data is acceptable.

When the target disk management data is determined to be acceptable at step 406, the target disk management data is considered to comprise correct data layout information. The controller 304 then accesses the optical disk 306 according to the target disk management data without reading the other disk management data copies (step 408). Though the other disk management data copies are not read when accessing the optical disk 306 according to the target disk management data in this embodiment, they may still be read to facilitate the accessing based on different applications. Thus, compared to the conventional method 200, the optical disk drive 300 does not need to read all disk management data copies of the optical disk 206, and a delayed time period due to reading of the disk management data is reduced, thereby improving performance of the optical disk drive 300. When the target disk management data is determined to be not acceptable at step 406, the controller 304 directs the pickup head 302 to read another disk management data copy from the optical disk to obtain a new target disk management data (step 410). The accuracy measure of the new target disk management data is then calculated at step 404 to determine whether the new target disk management data is acceptable. If so, the controller 304 then accesses the optical disk 306 according to the new target disk management data without reading the other disk management data copies (step 408). Though the other disk management data copies are not read when accessing the optical disk 306 according to the new target disk management data in this embodiment, they may still be read to facilitate the accessing based on different applications.

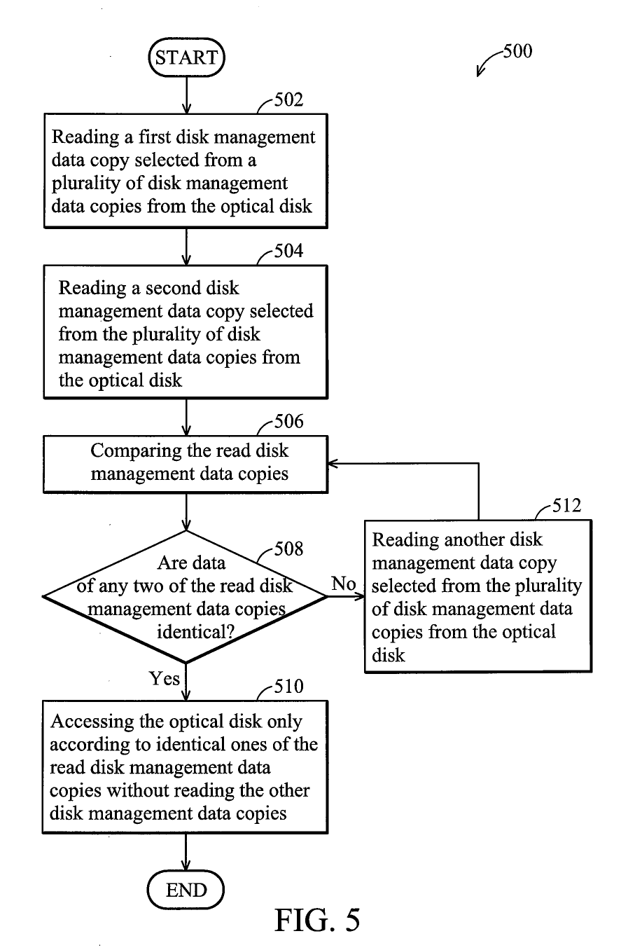

According to method 400 of FIG. 4, the optical disk drive 300 may read one of the multiple disk management data copies to obtain data layout information of the optical disk 306. The optical disk drive 300, however, can also read two of the multiple disk management data copies to obtain data layout information of the optical disk 306. Referring to FIG. 5, a flowchart of a method 500 for reading disk management data of an optical disk according to the invention is shown. The controller 304 first directs the pickup head 302 to read a first disk management data copy from the optical disk 306 (step 502), wherein the first disk management data copy is one of the multiple disk management data copies stored on the optical disk 306. The controller 304 then directs the pickup head 302 to read a second disk management data copy from the optical disk 306 (step 504), wherein the second disk management data copy is different from the first disk management data copy. For example, the optical disk 306 may be a BD-RE disk, and the pickup head 302 may read the first and second data management structures DMS1 and DMS2 as the first disk management data copy and the second disk management data copy.

After the first disk management data copy and the second disk management data copy are obtained, a decision circuit 308 of the controller 304 compares read disk management data copies including the first disk management data copy and the second disk management data copy (step 506). If any two of the read disk management data copies are identical at step 508, the two identical disk management data copies are believed to comprise correct data layout information. The controller 304 then accesses the optical disk 306 according to the identical ones of the read disk management data copies without reading the other disk management data copies (step 510). Though the other disk management data copies are not read when accessing the optical disk 306 according to the identical ones of the read disk management data copies in this embodiment, they may still be read to facilitate the accessing based on different applications. Thus, compared to the conventional method 200, the optical disk drive 300 does not need to read all disk management data copies of the optical disk 206, and a delayed time period due to reading of the disk management data is reduced, thereby improving performance of the optical disk drive 300. When any two of the read disk management data copies are not identical at step 508, the controller 304 directs the pickup head 302 to read another disk management data copy from the optical disk (step 512). The loop of steps 512, 506, and 508 will continue until two identical disk management data copies are found. If so, the controller 304 then accesses the optical disk 306 according to the two identical disk management data copies without reading the other disk management data copies (step 510). Though the other disk management data copies are not read when accessing the optical disk 306 according to the two identical disk management data copies in this embodiment, they may still be read to facilitate the accessing based on different applications.

The invention provides a method for reading disk management data copies of an optical disk. To determine data layout information of the optical disk, not all of the multiple disk management data copies stored on the optical disk are read. An optical disk drive then accesses the optical disk according to the data layout information. A delay time due to reading of the disk management data copies is therefore reduced, thus improving performance of the optical disk drive.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for reading disk management data of an optical disk, wherein the disk management data comprises data layout information of the optical disk, and a plurality of disk management data copies of the disk management data is stored on the optical disk, comprising:
reading a first disk management data copy selected from the plurality of disk management data copies from the optical disk;
calculating an accuracy measure of the first disk management data copy;
determining whether the accuracy measure of the first disk management data copy is acceptable; and
when the accuracy measure of the first disk management data copy is acceptable, accessing the optical disk according to the first disk management data copy.

2. The method as claimed in claim 1, wherein the optical disk is accessed according to the first disk management data copy without reading the other disk management data copies.

3. The method as claimed in claim 1, wherein the method further comprises:
when the accuracy measure of the first disk management data copy is not acceptable, reading a second disk management data copy selected from the plurality of disk management data copies from the optical disk, wherein the second disk management data copy is not the first disk management data copy;
calculating an accuracy measure of the second disk management data copy;
determining whether the accuracy measure of the second disk management data copy is acceptable; and
when the accuracy measure of the second disk management data copy is acceptable, accessing the optical disk according to the second disk management data copy without reading the other disk management data copies

4. The method as claimed in claim 1, wherein the accuracy measure is an error detection code (EDC) check of the first disk management data copy.

5. The method as claimed in claim 1, wherein the accuracy measure is an error rate of the first disk management data copy, and the error rate of the first disk management data copy is determined to be acceptable when the error rate of the first disk management data copy is smaller than a threshold.

6. The method as claimed in claim 1, wherein each of the disk management data copies comprises an update count recording a frequency with which the disk management data copy has been updated.

7. The method as claimed in claim 6, wherein the first disk management data copy is selected under the criteria where the first disk management data copy has the greatest update count in comparison with those of the other disk management data copies.{limitations for selection of a first disk management data copy}

8. The method as claimed in claim 1, wherein the optical disk is a rewritable blu-ray disk (BD-RE), and the disk management data is a defect management structure (DMS) comprising a disk definition structure (DDS) and a defect list (DFL), wherein the disk definition structure stores start addresses and end addresses of all sectors of the optical disk, and the defect list stores addresses of all defect blocks and corresponding replacement blocks of the optical disk.

9. The method as claimed in claim 1, wherein the optical disk is a rewritable digital versatile disk (DVD-RW), and the disk management data is record management data (RMD) stored in a record management zone (RMZ) of the optical disk.

10. A method for reading disk management data of an optical disk, wherein the disk management data comprises data layout information of the optical disk, and a plurality of disk management data copies of the disk management data is stored on the optical disk, comprising:
reading a first disk management data copy selected from the plurality of disk management data copies from the optical disk;
reading a second disk management data copy selected from the plurality of disk management data copies from the optical disk;
comparing the first disk management data copy with the second disk management data copy;
determining whether data of the first disk management data copy and the second disk management data copy are identical; and
when data of the first disk management data copy and the second data copy are identical, accessing the optical disk according to the first disk management data copy or the second data copy without reading the other disk management data copies.

11. The method as claimed in claim 10, wherein the method further comprises:
when data of the first disk management data copy and the second data copy are not identical, reading a third disk management data copy selected from the plurality of disk management data copies from the optical disk, wherein the third disk management data copy is not the first disk management data copy or the second data copy;
comparing the third disk management data copy with the first disk management data copy and the second disk management data copy;
determining whether data of the third disk management data copy is identical to data of the first disk management data copy or the second disk management data copy; and
when data of the third disk management data copy is identical to data of the first disk management data copy or the second disk management data copy, accessing the optical disk according to the third disk management data copy without reading the other disk management data copies.

12. The method as claimed in claim 10, wherein each of the disk management data copies comprises an update count recording a frequency with which the disk management data copies have been updated.

13. The method as claimed in claim 12, wherein the first disk management data copy and the second disk management data copy are selected under the criteria where the first disk management data copy and the second disk management data copy have a greater update count in comparison with those of the other disk management data copies.

14. The method as claimed in claim 10, wherein the optical disk is a rewritable blu-ray disk (BD-RE), and the disk management data is a defect management structure (DMS) comprising a disk definition structure (DDS) and a defect list (DFL), wherein the disk definition structure stores start addresses and end addresses of all sectors of the optical disk, and the defect list stores addresses of all defect blocks and corresponding replacement blocks of the optical disk.

15. The method as claimed in claim 10, wherein the optical disk is a rewritable digital versatile disk (DVD-RW), and the disk management data is record management data (RMD) stored in a record management zone (RMZ) of the optical disk.

16. An optical disk drive, accessing an optical disk, wherein disk management data comprises data layout information of the optical disk, and a plurality of disk management data copies of the disk management data is stored on the optical disk, comprising:
a pickup head, reading a first disk management data copy selected from the plurality of disk management data copies from the optical disk;
a controller, calculating an accuracy measure of the first disk management data copy, determining whether the accuracy measure of the first disk management data copy is acceptable, and when the accuracy measure of the first disk management data copy is acceptable, controlling the pickup head to access the optical disk according to the first disk management data copy.

17. The optical disk drive as claimed in claim 16, wherein the optical disk is accessed according to the first disk management data copy without reading the other disk management data copies.

18. The optical disk drive as claimed in claim 16, wherein when the accuracy measure of the first disk management data copy is not acceptable, the pickup head reads a second disk management data copy selected from the plurality of disk management data copies from the optical disk, and the controller calculates an accuracy measure of the second disk management data copy, determines whether the accuracy measure of the second disk management data copy is acceptable, and controls the pickup head to access the optical disk according to the second disk management data copy without reading the other disk management data copies when the accuracy measure of the second disk management data copy is acceptable.

19. The optical disk drive as claimed in claim 16, wherein the accuracy measure is an error detection code (EDC) check of the first disk management data copy.

20. The optical disk drive as claimed in claim 16, wherein the accuracy measure is an error rate of the first disk management data copy, and the error rate of the first disk management data copy is determined to be acceptable when the error rate of the first disk management data copy is smaller than a threshold.

21. The optical disk drive as claimed in claim 16, wherein each of the disk management data copies comprises an update count recording a frequency with which the disk management data copy has been updated.

22. The optical disk drive as claimed in claim 21, wherein the first disk management data copy is selected under the criteria where the first disk management data copy has the greatest update count in comparison with those of the other disk management data copies.

23. The optical disk drive as claimed in claim 16, wherein the optical disk is a rewritable blu-ray disk (BD-RE), and the disk management data is a defect management structure (DMS) comprising a disk definition structure (DDS) and a defect list (DFL), wherein the disk definition structure stores start addresses and end addresses of all sectors of the optical disk, and the defect list stores addresses of all defect blocks and corresponding replacement blocks of the optical disk.

24. The optical disk drive as claimed in claim 16, wherein the optical disk is a rewritable digital versatile disk (DVD-RW), and the disk management data is record management data (RMD) stored in a record management zone (RMZ) of the optical disk.
